(19) United States
(12) Patent Application Publication
(10) Pub. No.: US 2026/0138215 A1
(43) Pub. Date: May 21, 2026

(54) DEVICE FOR DETECTING SCATTERED RADIATION WITH A LIGHT-GUIDING CHANNEL

(71) Applicant: TRUMPF LASER- UND SYSTEMTECHNIK SE, Ditzingen (DE)

(72) Inventors: Christof SAILER, Ditzingen (DE); Stefan DÖRR, Bietigheim-Bissingen (DE); Franziska HAFNER, Korntal-Münchingen (DE)

(21) Appl. No.: 19/452,913

(22) Filed: Jan. 20, 2026

Related U.S. Application Data
(63) Continuation of application No. PCT/EP2024/070662, filed on Jul. 22, 2024.

(30) Foreign Application Priority Data
Aug. 10, 2023 (DE) 10 2023 121 401.2

(51) Int. Cl. B23K 26/70; B23K 26/035

(52) U.S. Cl. CPC B23K 26/705; B23K 26/035

(57) ABSTRACT

A device for detecting scattered radiation in a beam path of a laser system includes an annular main body that forms a light-guiding channel in an interior thereof. The main body has a first opening and a second opening spaced apart from one another in a wall of the main body. Each of the first opening and the second opening forms a passage for the scattered radiation into the light-guiding channel. The light-guiding channel has a detection portion, in which a radiation intensity of the scattered radiation received by the light-guiding channel is capable of being detected.

### CROSS REFERENCE TO RELATED APPLICATIONS

This application is a continuation of International Application No. PCT/EP2024/070662 (WO 2025/031766A1 ), filed on Jul. 22, 2024, and claims benefit to German Patent Application No. DE 10 2023 121 401.2, filed on Aug. 10, 2023. The aforementioned applications are hereby incorporated by reference herein.

### FIELD

Embodiments of the present invention relate to a device for detecting scattered radiation in the beam path of a laser system.

### BACKGROUND

Laser systems, in particular multi-axis laser systems, have become an indispensable technology in many industries in recent years. They offer high precision and high flexibility, and enable workpieces to be processed, i.e., cut, welded and/or coated, efficiently. Laser systems have a variety of optical elements, such as lenses, mirrors, and protective glasses. In order to enable efficient and process-appropriate machining of the respective workpiece, it is necessary that the optical elements do not have any significant defects, for example caused by an excessive degree of contamination.

The European publication EP 3 978 179 A1 is known from the prior art. This discloses a processing head in which contamination appearing on a protective glass is detected by an optical sensor. For this purpose, the protective glass has an anti-reflection film on the surfaces running orthogonally to the laser beam, while it has a reflective film on the surfaces running along the direction of the laser beam. In this manner, a signal is sent to the optical sensor when there is dirt on the protective glass. This signal is usually reflected several times by the protective glass before it reaches the optical sensor.

### SUMMARY

Embodiments of the present invention provide a device for detecting scattered radiation in a beam path of a laser system. The device includes an annular main body that forms a light-guiding channel in an interior thereof. The main body has a first opening and a second opening spaced apart from one another in a wall of the main body. Each of the first opening and the second opening forms a passage for the scattered radiation into the light-guiding channel. The light-guiding channel has a detection portion, in which a radiation intensity of the scattered radiation received by the light-guiding channel is capable of being detected.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic view of a laser system according to some embodiments;

FIG. 2 shows a schematic sectional view of a state detection system having a device, a detector, and an optical element, according to some embodiments;

FIG. 3 shows a schematic plan view of a device having a detector, according to some embodiments;

FIG. 4 shows a schematic perspective view of a device having an aperture unit and a detector connected to a control unit by a cable, according to some embodiments;

FIG. 5 shows a schematic plan view of a device having an opening unit with three openings according to some embodiments; and

FIG. 6 shows a diagram in which reflected scattered radiation transmitted to a detector is normalized to the actually reflected scattered radiation according to some embodiments.

### DETAILED DESCRIPTION

Embodiments of the present invention provide an improved device for detecting scattered radiation in order to determine the state of an optical interface regardless of the position of the optical interface where a defect occurs. Embodiments of the present invention also provide a device which does not increase, or only slightly increases, the complexity of the evaluation of the detected signal. The device can be integrated into existing laser systems without requiring additional electronics. Furthermore, embodiments of the present invention can ensure that the device can be reliably produced in large quantities.

Accordingly, embodiments of the present invention provide a device for detecting scattered radiation in the beam path of a laser system. The device can be referred to as a state detection device, as it can be suitable for detecting a state of an optical interface of a substantially rotationally symmetrical optical element through which a laser beam is directed. The optical element can be a lens, a mirror, and/or a protective glass. The optical interface can be smooth and thus differ from a diffractive optical element. The laser beam can impinge on the optical element substantially orthogonally, in particular if the optical element is a lens and/or a protective glass. The laser beam can also impinge on the optical element at an angle, in particular if the optical element is a mirror and/or a lens. The detected scattered radiation can provide information about whether there is a defect on the optical interface. For example, the degree of contamination of the optical interface can be detected. The device can be in communication, at least indirectly, with a control unit in order to communicate the detected state of the optical interface to the control unit. For example, if the detected state exceeds a limit value, the control unit can communicate this to a laser system operator via a user interface so that the optical interface can be cleaned and/or replaced, for example. The beam path can describe the path along which the laser beam is guided through the laser system and the components arranged therein. The beam path can vary depending on the process. The beam path can run from a laser source via a fiber optic cable into a laser quill, from where it can enter primary laser optics via a movement unit. The course of the beam path is determined by optical elements, in particular mirrors and lenses.

The device has an annular main body which forms a light-guiding channel in its interior. The annular body can be designed to transmit the scattered radiation to a detection portion, which is why it can also be referred to as a transmission element. In particular, the light-guiding channel is formed entirely inside the annular main body. The annular main body can define a hollow space within which the light-guiding channel runs.

The annular main body has a first opening and a second opening which are spaced apart from one another in a wall of the main body, in particular along an inner circumference of the main body, and each form a passage for the scattered radiation into the light-guiding channel. The first opening and the second opening may together be referred to as an opening unit. The opening unit is configured and provided to receive scattered radiation reflected from the optical interface. The reflected scattered radiation may be due to a defect on the optical interface. For example, the optical interface may be contaminated by metal dust or oil mist, which cause Mie scattering when interacting with the laser beam. The contamination of the optical interface can be in the dimension of 0.5 μm to 10 μm, in which Mie scattering is predominant. It can also have larger dimensions in which classical scattering according to Snell's law of refraction is predominant. The first opening and the second opening allow the reflected radiation to enter the annular main body and its light-guiding channel. The laser beam directed at the optical interface can be reflected or diffracted by the defect such that it deviates from the intended path of the laser radiation, i.e., the beam path, and thus reflects the scattered radiation. The intensity and direction of the scattered radiation depend on the dimension and internal properties of the defect. The larger the defect, the more intense the scattered radiation and the less intense the laser beam passing through the optical element.

The light-guiding channel of the device has a detection portion in which a radiation intensity of the scattered radiation received by the light-guiding channel can be detected. The detection portion may be adapted to accommodate a detector, which is why it may also be referred to as a detector receptacle. The detection portion can be configured and provided to accommodate a detector, in particular in the form of a photodiode, for detecting the scattered radiation. The detection portion may have a shape such that the detector is received in the detection portion in a form-fitting and/or force-fitting manner. The detection portion can be machined into the device. The detector can be a photodiode. This is particularly suitable for laser beams which are formed as infrared radiation.

The annular main body can be configured and provided accordingly to transmit the scattered radiation received by the opening unit at least in sections along a circumferential direction of the optical element to the detection portion and in particular to the detector arranged therein. As a transmission element, the main body fulfills the function of transmitting the reflected scattered radiation received by the openings to the detection portion. This transmission takes place at least in sections along the circumferential direction of the main body. The main body may be designed as a hollow channel within the device. The substantially rotationally symmetrical optical element has a circumferential direction about the axis of rotation. The fact that the received scattered radiation extends at least partially along the circumferential direction ensures that the detection portion and the openings define an angular span with respect to the axis of rotation. The reflected scattered radiation therefore does not reach the detection portion via the shortest path, which prevents the detected signal from being distorted by the defect causing the reflected scattered radiation being in the immediate vicinity of the detection portion. The scattered radiation received by the openings can be transmitted to the detection portion, for example, at 60°, 90°, 120° and/or 180° along the circumferential direction of the main body.

In this way, defects can be detected reliably and with a comparable signal level regardless of their position relative to the detector and the detection portion. The detected scattered radiation can be spatially homogenized and detected regardless of location. It can also enable reliable detection of minor defects. The intensity with which the reflected scattered radiation impinges on the aperture unit can be inversely proportional to the square of the radius relative to the center of the optical interface, i.e., the axis of rotation. The further the defect is from the center of the optical interface, the greater the intensity of the reflected scattered radiation can distort the detected signal. In this respect, the transmission of the received scattered radiation provides a remedy, at least in sections along the circumferential direction. The detection portion can accommodate exactly one detector. On the one hand, this facilitates communication between the device and the control unit, since only one detector needs to be taken into account. Furthermore, the integration of the device into the processing head of the laser system is simplified by the fact that the single detector only requires one cable. Accordingly, the device contributes to detecting scattered radiation in order to determine the state of an optical interface regardless of the position at the optical interface where a defect occurs. Furthermore, it helps to ensure that the complexity of evaluating the detected signal is not increased or is only increased insignificantly. It can also be integrated into existing laser systems without requiring additional electronics. It can also be reliably produced in large quantities.

In one embodiment, the first opening and the second opening are spaced apart from one another along a circumferential direction of the annular main body, in particular by an angular span of at least 60°, in particular 120°, along the circumferential direction. The scattered radiation reflected from the optical interface can thus be received by the first opening and the second opening at two predetermined locations spaced apart from one another. This further contributes to the homogenization of the signal detected by the detection portion and consequently to the detected state. The first opening and the second opening can each be arranged on an inner side of the annular main body. The angular span by which the first opening is spaced from the second opening can also be 180°. This ensures a maximum distance between the first opening and the second opening, whereby a defect that causes disproportionately reflected scattered radiation in the first opening causes disproportionately reflected scattered radiation in the second opening, so that the signal detected by the detector is balanced and free of distortions. The opening angle of the first opening and the second opening is small compared to the circumference of the main body. In this way, a sensor signal can be received largely independently of the defect and the position of the defect. Furthermore, particles with a size of the same wavelength as the laser light can be efficiently detected in this manner.

In one embodiment, the main body has a third opening which is spaced apart from the first opening and the second opening along the circumferential direction, in particular by an angular span of at least 60° in each case, in particular 120° in each case, along the circumferential direction. The third opening further contributes to the homogenization of the signal detected by the detector and consequently to the detected state. The first opening, the second opening and the third opening can be evenly distributed along the circumferential direction, i.e., offset by 120° from one another. This further counteracts unwanted weighting of a defect due to its position in close proximity to an opening. The third opening can be arranged on the inner side of the main body. The first opening, the second opening, and the third opening may each have a chamfered opening slope that enables efficient detection of the reflected scattered radiation. For example, the openings may be chamfered at an angle of at least 30° relative to the plane in which the optical interface runs. These angles have proven to be advantageous when the reflected scattered radiation is the scattered radiation reflected by an oil mist or metal dust. This is because they are reflected according to the concept of Mie scattering and in this case have an angle of 15° to 30° relative to the plane in which the optical interface runs. The first opening, the second opening and the third opening can be arranged such that the scattered radiation received by the opening unit is transmitted from the main body and its light-guiding channel, thus the transmission element, completely along the circumferential direction to the detection portion. This further contributes to the homogenization of the signal detected by the detection portion and consequently to the detected state.

In one embodiment, the first opening is the opening furthest away from the detection portion, in particular is arranged diametrically opposite the detection portion, and defines a larger opening angle than the second opening and in particular than the second opening and the third opening. Because the furthest opening defines the largest opening angle, any attenuation loss of the received scattered radiation within the main body is counteracted. The larger opening angle causes the first opening to receive more reflected scattered radiation than the second opening and in particular than the second opening and the third opening. This compensates for the unavoidable attenuation that the scattered radiation experiences in the light-guiding channel on the way from the first opening along the circumferential direction to the detection portion. In particular, the larger opening angle is adapted to the position of the first opening. Because the second opening, and in particular the second opening and the third opening, are closer to the detection portion than the first opening, the scattered radiation received by them experiences less attenuation. In this respect, the opening angle of the second opening and the third opening is smaller than that of the first opening, without this affecting the detected signal. The larger opening angle of the first opening ensures that the signal received by the first opening is weighted with a weighting corresponding to its intensity in a sum signal that is received by the detection portion and subsequently by the detector. A linear relationship can exist between the size of the opening angle of the respective opening and the distance of the respective opening angle from the detection portion.

In principle, it can be provided that an opening cross-section and/or an opening angle of the openings increases with the distance of the respective opening from the detection portion in the circumferential direction of the main body.

In a configuration in which only two openings (i.e., the first opening and the second opening) are provided in the main body, it may be preferred that the openings are opposite one another in the circumferential direction of the main body, i.e., are spaced apart by 180°, and that both openings have the same distance from the detection portion, as well as the same opening cross-section and the same opening angle. In one embodiment, the light-guiding channel has a reflective surface, which is in particular made of a non-ferrous metal, a precious metal, and/or an alloy. The light-guiding channel, also known as an annular channel, can extend from the detection portion by substantially 360° around the axis of rotation. It can have a constant radius. The reflective surface can be selected such that a sufficiently high reflection is ensured at the wavelength of the laser beam. The sufficiently high reflection is characterized by the fact that it transmits the scattered radiation received by the openings to the detection portion with comparable intensity. For example, more than 90%, in particular more than 95%, of the scattered radiation received by the openings can be passed on to the detection portion. When the received scattered radiation is transmitted, it can be scattered multiple times. An attenuation of the scattering can be achieved with a reflectivity T of the surface of the light-guiding channel and a number of scatterings n by a factor of Tn. In particular, copper can be selected as a non-ferrous metal. Copper can be machined by diamond milling. Consequently, the light-guiding channel can be efficiently machined into a copper main body. Brass can be selected as an alloy, which can also be machined. The light-guiding channel can consequently be efficiently machined into a brass main body. Furthermore, in particular, not only the surface of the light-guiding channel can be made of a non-ferrous metal, a precious metal, and/or an alloy, but the entire main body or the entire device. This increases the efficiency in producing the device.

In one embodiment, the reflective surface is an applied coating. This means that a material can be used for the device without having to worry about corresponding reflection properties. Only the surface of the light-guiding channel needs to be coated accordingly to ensure a sufficiently high transmission rate to the detection portion of the opening unit.

In one embodiment, the light-guiding channel forms a circular cross-section. The circular shape has a positive effect on the reflection properties of the light-guiding channel, which can also be referred to as an annular channel, as a transmission element. Furthermore, the circular shape ensures efficient machining of the light-guiding channel. The circular cross-section of the light-guiding channel can have a constant diameter. Alternatively, the diameter of the circular cross-section may be larger in the area of the respective openings than in the remaining area.

In one embodiment, the device has an upper part and a lower part which form the first opening, the second opening, optionally the third opening, the detection portion and the light-guiding channel and which are in particular substantially identical in construction to one another. The upper part and the lower part can be designed so that, when joined together, the openings, the detection portion and the light-guiding channel are designed as hollow spaces. This allows the device to be produced efficiently. Furthermore, the upper and lower parts can be identical in construction, which further increases production efficiency. For example, the hollow spaces forming the openings, the detection portion and the light-guiding channel can be machined into the upper part and the lower part.

In one embodiment, the device further comprises a fiber optic cable, in particular in the manner of optical quartz fiber, extending in the light-guiding channel. The fiber optic cable can have light entry portions on its radially inward-facing inner side, each of which is arranged at the location of one of the openings in the main body. For example, a surface of an optical quartz fiber can be ablated to form a light entry portion.

The disclosure further relates to a state detection system. This includes a device according to the above disclosure. Furthermore, the state detection system includes a detector which is accommodated within the detection portion and which is provided to detect the reflected scattered radiation. The disclosure of the detector with respect to the device is to be applied accordingly to the state detection system. The detector of the state detection system is configured to receive the transmitted scattered radiation as a sum signal. The sum signal is formed from the scattered radiation received by the openings and transmitted via the light-guiding channel. For example, a first signal of the sum signal from the first opening, a second signal of the sum signal from the second opening and/or a third signal of the sum signal from the third opening can have been received. The sum signal can be weighted by the corresponding opening angles of the respective openings, in this way the state detected by the state detection system is independent of the position of the respective defect of the optical interface. By forming the sum signal, the arrangement of a plurality of sensors is no longer necessary. This facilitates both the construction of the state monitoring system and its integration into an existing laser system. The state detection system thus contributes to detecting scattered radiation in order to determine the state of an optical interface regardless of the position at the optical interface where a defect occurs. Furthermore, it helps to ensure that the complexity of evaluating the detected signal is not increased or is only increased insignificantly. It can also be integrated into existing laser systems without requiring additional electronics. It can also be reliably produced in large quantities.

In one embodiment, the state detection system has an aperture unit which is provided to regulate the scattered radiation arriving at the detector. The aperture unit can ensure that the scattered radiation transmitted from the main body as a transmission element to the detector only impinges on the detector from a predetermined direction. This facilitates the objective evaluation of the detector because signals arriving from the side, which can distort the sum signal, are regulated accordingly. The aperture unit can be adjustable so that the regulation it provides is adapted to the optical interface being monitored. For example, the regulation when detecting the state of a mirror may differ from the regulation when detecting the state of a lens.

In one embodiment, the aperture unit has two tubular elements arranged in the circumferential direction on both sides of the detector. This ensures that the detector only detects scattered radiation impinging on it orthogonally. The tubular elements can be identical in construction to one another. They can be held in the corresponding recesses of the device in a force-fitting and/or form-fitting manner.

In one embodiment, the state detection system further comprises an optical element through which a laser beam can be directed, in particular the lens, the mirror, the protective glass, wherein the device and the optical element extend in planes that are plane-parallel to one another, wherein a distance between the planes is selected such that the scattered radiation reflected at an optical interface of the optical element impinges on the opening unit at an angle of 15° to 30°. The span of the angle may result from the fact that the exact position of the defect causing the scattered radiation varies. Because the defect can be of a size that corresponds to the wavelength of the laser beam, Mie scattering can emanate from the defect. For particles with dimensions of 0.5 μm to 10μm, a laser beam with an infrared laser can exhibit reflected scattered radiation that deviates by 15° to 30° from the plane in which the optical interface runs. In this respect, the state detection system is optimized for defects that cause Mie scattering.

In one embodiment, the state detection system further includes a control unit to which the detector transmits the received sum signal, wherein the control unit determines a degree of contamination of the optical interface from the received sum signal. For this purpose, a limit value can be stored in the control unit for each optical interface, above which the control unit classifies the degree of contamination as critical. As soon as the contamination level of an optical interface is classified as critical, the control unit can send a corresponding alarm signal to a user interface so that an operator of the system is alerted to the corresponding contamination of the optical interface. A lookup table can be stored in the control unit in which a critical degree of contamination is listed for each optical interface. The lookup table can have predetermined values or can be modified by an operator.

The disclosure further relates to a laser system, i.e., a laser processing device, for aligning a laser beam on a workpiece. The laser system has a state detection system according to the above disclosure and a processing head which aligns a laser beam on a workpiece.

Preferred further embodiments of the invention are explained in greater detail by means of the following description of the figures.

Preferred exemplary embodiments are described below with reference to the figures. In this case, elements that are the same, similar, or have the same effect are provided with identical reference symbols in the different figures, and a repeated description of these elements is omitted in some instances to avoid redundancies.

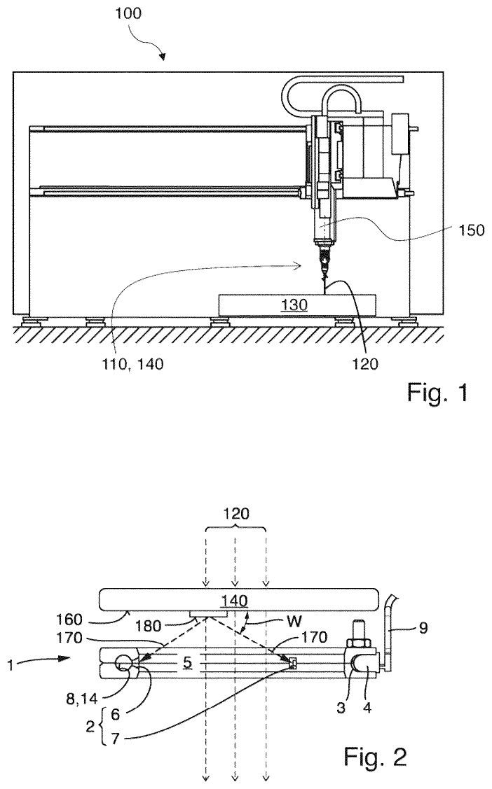

FIG. 1 shows a laser system 100 having a processing head 110 which aligns a laser beam 120 on a workpiece 130. The laser system 100 has a plurality of optical elements 140 which are substantially rotationally symmetrical. The optical elements 140 can be a lens, a mirror, and/or a protective glass. The at least one lens is provided to focus the laser beam 120. The at least one mirror is provided to redirect the laser beam 120. The at least one protective glass is provided to protect the processing head 110 and the laser optics arranged therein from external interference factors, such as reflected laser light. The respective optical elements 140 can be arranged in the processing head 110 and/or in a laser quill 150. The laser beam 120 is provided by a laser source (not shown), such as a disk laser, a diode laser, or a fiber laser. The laser source can guide the laser beam 120 by means of a fiber optic cable to the laser quill 150, within which the laser beam 120 is directed in parallel by means of lenses, in particular collimating lenses. The laser beam 120 is guided from the laser quill 150 into the processing head 110, in which the laser optics are arranged. The processing head 110 is controlled in accordance with the process and ensures appropriate alignment of the laser beam 120 on the workpiece 130. The laser system 110 may be a system for laser cutting, laser welding, and/or laser deposition welding. The individual optical elements 140 each have at least one optical interface 160 which forms a substantially smooth surface. If the optical interface 160 has a defect, for example due to contamination of the optical interface 160, reflected scattered radiation 170 emanates from each defect (see FIG. 2).

FIG. 2 shows a device 1, also referred to as a state detection device 1, for detecting a state of at least one optical interface 160 in a sectional view along a diameter of the state detection device 1. The state detection device 1 has an opening unit 2, namely a first opening 6 and a second opening 7, which receives scattered radiation 170 reflected by the optical interface 160. The state detection device 1 further has a detection portion 3 in which a detector 4, in particular in the form of a photodiode, is accommodated in order to detect and process the scattered radiation 170. The state detection device 1 further has a main body 5, which can also be referred to as a transmission element 5, which transmits the scattered radiation 170 received by the opening unit 2 along a circumferential direction U of the optical element 140 to the detector 4.

The laser beam 120 is substantially orthogonal to the optical interface 160. The optical element 140 having the optical interface 160 is arranged upstream of the state detection device 1 in the laser beam. The laser beam 120 passes through the optical element 140 which is transparent to the laser beam 120. There is a defect 180 on the optical interface 160 of the optical element 140 facing the state detection device 1. This can result, for example, from contamination of the optical element 140. The defect 180 interferes with the laser radiation 120 and causes the reflected scattered radiation 170. The larger the defect 180, the greater the reflected scattered radiation 170 and the smaller the laser radiation 120 that is guided along the intended beam path through the laser system 100.

The reflected scattered radiation 170 is received by the first opening 6 and by the second opening 7 of the opening unit 2 of the state detection device 1. The first opening 6 and the second opening 7 are arranged on an inner side of the state detection device 1. The annular main body 5 has a light-guiding channel 14 which has a reflective surface 8. The reflective surface 8 guides the scattered radiation 170 received through the first opening 6 and the second opening 7 along the circumferential direction U of the optical element 140 to the detection portion 3 in which the detector 4 is arranged. The reflective surface 8 can be part of the light-guiding channel 14 with a circular cross-section. The detector 4 detects the scattered radiation 170 received by the first opening 6 and the scattered radiation 170 received by the second opening 7 as a sum signal and transmits the sum signal to a control unit (not shown) via a cable 9. The first opening 6 is further away from the detector 4 than the second opening 7. Accordingly, the scattered radiation 170 received by the first opening 6 has to travel a longer distance than the scattered radiation 170 received by the second opening 7. Because the path from the first opening 6 is longer, the attenuation of the scattered radiation 170 received by the first opening 6 is greater than the attenuation of the scattered radiation 170 received by the second opening 7. In order to compensate for this effect of increased attenuation with the increased distance from the detector 4, the first opening 6 can have a larger opening area than the second opening 7, so that the first opening 6 receives relatively more scattered radiation 170. Accordingly, the sum signal detected by the detector 4 is weighted in correlation with the respective distance of the opening 6, 7. In this case, the defect 180 is eccentric on the optical interface 160. In particular, because the opening unit 2 has the first opening 6 and the second opening 7, the position of the defect 180 does not affect the result detected by the detector 4.

The laser source can, for example, generate laser beams, in particular infrared laser beams, with wavelengths of 0.4 μm and 1.5 μm, in particular of about 450 nm, of about 515 nm, between about 800 nm and about 1000 nm, or of about 1030 nm, 1060 nm or 1070 nm. The defect 180 can be around 0.5 μm to 10 μm. Accordingly, the laser beam 120 can scatter elastically at the defect 180 in the manner of Mie scattering. For a particle size between 0.5 μm and 10 μm, Mie scattering results in a scattering angle W of between 15° and 30°. Accordingly, the distance between the state device 1 and the optical interface 160 is selected such that, with a corresponding positioning of the defect 180 on the optical interface 160, the reflected scattered radiation is detected by the opening unit 2.

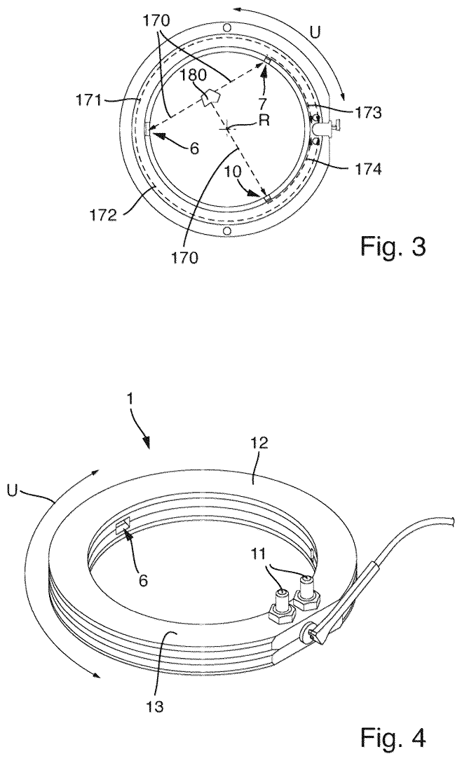

FIG. 3 shows the state detection device 1 in a plan view. The first opening 6 is arranged diametrically opposite the detection portion 3. The second opening 7 is provided at a distance of 120° from the first opening 6 along the circumferential direction U. Starting from the first opening 6 along the direction facing away from the second opening 7 along the circumferential direction U, a third opening 10 is provided at a distance of 120° from the first opening 6. The second opening 7 and the third opening 10 are each offset from the detection portion 3 by 60°, while the first opening 6 is offset from the detection portion 3 by 180°. Accordingly, the first opening is the opening furthest away because it is located opposite the detection portion 3. The first opening 6 therefore defines a larger opening area than the second opening 7 and the third opening 10. The first opening 6, the second opening 7, and the third opening 10 form the opening unit 2. The third opening 10 can be arranged analogously to the first opening 6 and the second opening 7 on the inner side of the state detection device 1.

The defect 180 is located on the optical interface 160 eccentrically from an axis of rotation R. The scattered radiation 170 reflected by the defect 180 is received by the opening unit 2, thus the first opening 6, the second opening 7, and the third opening 10, and then transmitted from the main body 5 along the circumferential direction to the detector 4. The detector 4 thus receives three signals of reflected scattered radiation 170 and can determine, in particular from the intensity of the respective detected signal and the time at which it receives the respective detected signal, the severity of the impairment of the optical interface 160 caused by the defect 180. From the first opening 6, the reflected scattered radiation 170 is transmitted along a first scattered radiation path 171 and along a second scattered radiation path 172 to the detector 4. In addition, the reflected scattered radiation is transmitted from the second opening 7 along a third scattered radiation path 173 and from the third opening 10 along a fourth scattered radiation path 174 to the detector 4. The first scattered radiation path 171 extends from the first opening 6 by 180° along the circumferential direction U of the optical element 140 to the detector 4. The second scattered radiation path 172 also extends from the first opening 6 by 180° along the circumferential direction U of the optical element 140 to the detector 4, but in the opposite direction to the first scattered radiation path 171. The third scattered radiation path 173 extends from the second opening 7 by 60° along the circumferential direction U of the optical element 140 to the detector 4 and the fourth scattered radiation path 174 extends from the third opening 10 by 60° along the circumferential direction U of the optical element 140 to the detector 4. The detector 4 receives the signals received according to the respective scattered radiation paths 171, 172, 173, 174 as a sum signal and forwards them to a control unit. The control unit can detect a state of the optical interface 160 from the received sum signal.

FIG. 4 shows the state detection device 1 in a perspective view. The first opening 6 has chamfered opening surfaces in order to optimally capture the scattered radiation 170 reflected by the optical interface 160. The chamfer angle may, for example, be at least 30° relative to the plane along which the optical element 140 extends. In this way, the Mie scattering reflected by a defect 170 is efficiently received by the first opening 6. Likewise, the second opening 7 and the third opening 10 can have chamfered opening surfaces with a chamfer angle of at least 30°. An aperture unit 11 is arranged in the region of the detector 4. The aperture unit 11 regulates the scattered radiation 170 arriving at the detector 4. It can consist of two tubular elements arranged on either side of the detector 4. The tubular elements can each be embedded in a corresponding opening of the state detection device 1. The scattered radiation 170 arriving at the detector 4 can be detected via the position and/or the diameter of the tubular elements.

The main body 5 has an upper part 12 and a lower part 13. The upper part 12 and the lower part 13 can be connected to one another in a force-fitting manner, in particular by screwing, and/or in a materially-bonded manner. Together they form the light-guiding channel 14 with the circular cross-section. The upper part 12 and the lower part 13 can be identical in construction to one another. This increases the efficiency in producing the state detection device 1. The state detection device 1 can be made of a non-ferrous metal, such as copper, into which the light-guiding channel 14 is diamond-milled. The state device 1 can also be made of a precious metal. The state device 1 can also be made of an alloy, such as brass, into which the light-guiding channel 14 is milled. Furthermore, the opening unit 2, thus the openings, as well as the detection portion 3, can be machined into the state device 1.

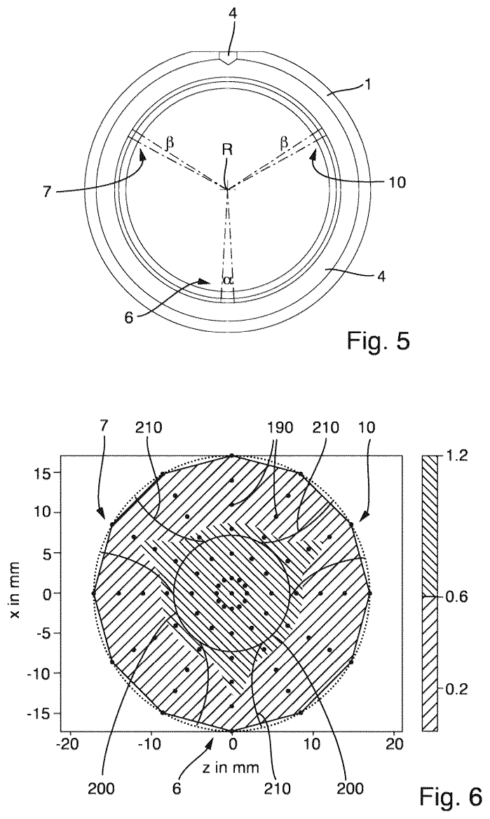

FIG. 5 shows a sectional plan view of the state detection device 1. The detection portion 3 is arranged diametrically opposite the first opening 6. The first opening 6 extends along an opening angle α. The opening angle α results in a first opening area of the first opening 6. In both directions along the circumferential direction U, starting from the first opening 6, the second opening 7 and the third opening 10 are arranged offset by 120°. These each extend along an opening angle β. The opening angle β results in a second opening area of the second opening 7 and an equally large third opening area of the third opening 10. The first opening area is larger than the second opening area and larger than the third opening area because the first opening 6 is further away from the detection portion 3 than the second opening 7 and the third opening 10, so that the scattered radiation 170 detected by the first opening area 6 is subject to greater attenuation than the scattered radiation 170 detected by the second opening 7 and the third opening 10. The first opening 6, the second opening 7, and the third opening 10 are connected to the detection portion 4 via the light-guiding channel 14. This extends in a circular manner about the axis of rotation R, which is the center of the optical interface 160.

FIG. 6 schematically shows a diagram in which reflected scattered radiation 170 transmitted to the detector 4 is normalized to the actual reflected scattered radiation 170. The individual points 190 represent measurement points. The dashed outer diameter in FIG. 6 corresponds to the inner diameter of the annular main body 5. In the embodiment of FIG. 6, the first opening 6, the second opening 7, and the third opening 10 are arranged according to the embodiment of FIG. 5. In a central region 200, the design of the opening unit 2 enables the actually reflected scattered radiation 170 to be completely detected and transmitted to the detector 4. Even in an extended region 210, which extends between the central region 200 and the respective openings 6, 7, 10, the arrangement of the opening unit 2 according to this embodiment enables approximately 80% of the actually reflected scattered radiation 170 to be detected. In the region not covered by the central region 200 or the extended region 210, less than 80%, in particular less than 60%, of the actually reflected scattered radiation 170 is detected. This does not affect the state detected by the state detection device 1 in that defects 180 located outside the central region 200 and the machined region 210 have less of an impact on the laser beam 120 and cause less intense scattered radiation 170. Thus, the arrangement of the opening unit 2 in this exemplary embodiment results in an optimal compromise between state detection and the number of openings 6, 7, 10. Too large a number of openings, for example five or more openings, may be disadvantageous in certain configurations because this would result in increased reflection of scattered radiation out of the light-guiding channel 14 before the reflected scattered radiation 170 has reached the detector 4.

Insofar as applicable, all individual features presented in the exemplary embodiments can be combined with one another and/or interchanged, without departing from the scope of the invention.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

1 Device, state detection device
2 Opening unit
3 Detection portion
4 Detector
5 Main body
6 First opening
7 Second opening
8 Reflective surface
9 Cable
10 Third opening
11 Aperture unit
12 Upper part
13 Lower part
14 Light-guiding channel
100 Laser system
110 Processing head
120 Laser beam
130 Workpiece
140 Optical element
150 Laser quill
160 Optical interface
170 Scattered radiation
171 First scattered radiation path
172 Second scattered radiation path
173 Third scattered radiation path
174 Fourth scattered radiation path
180 Defect
190 Measurement points
200 Central region
210 Extended region
U Circumferential direction
W Scattering angle
R Axis of rotation
α First opening angle
β Second opening angle

1. A device for detecting scattered radiation in a beam path of a laser system, the device comprising:
an annular main body that forms a light-guiding channel in an interior thereof;
wherein the main body has a first opening and a second opening spaced apart from one another in a wall of the main body, and each of the first opening and the second opening forms a passage for the scattered radiation into the light-guiding channel; and
wherein the light-guiding channel has a detection portion in which a radiation intensity of the scattered radiation received by the light-guiding channel is capable of being detected.

2. The device according to claim 1, wherein the first opening and the second opening are spaced apart from one another along a circumferential direction of the annular main body by an angular span of at least 60°.

3. The device according to claim 2, wherein the main body has a third opening spaced apart from the first opening and the second opening along the circumferential direction.

4. The device according to claim 1, wherein
the first opening is farther away from the detection portion and defines a larger opening angle than the second opening.

5. The device according to claim 1, wherein the light-guiding channel comprises a reflective surface.

6. The device according to claim 5, wherein the reflective surface comprises a non-ferrous metal, a precious metal, and/or an alloy.

7. The device according to claim 5, wherein the reflective surface comprises an applied coating.

8. The device according to claim 1, wherein the light-guiding channel has a circular cross-section.

9. The device according to claim 1, wherein the main body comprises an upper part and a lower part, which form the first opening, the second opening, the detection portion, and the light-guiding channel.

10. The device according to claim 1, further comprising a fiber optic cable extending in the light-guiding channel.

11. A state detection system comprising:
a device according to claim 1; and
a detector disposed within the detection portion for detecting the scattered radiation;
wherein the detector is configured to receive the scattered radiation as a sum signal.

12. The state detection system according to claim 11, further comprising an aperture for regulating the scattered radiation arriving at the detector.

13. The state detection system according to claim 12, wherein the aperture comprises two tubular elements arranged in a circumferential direction on both sides of the detector.

14. The state detection system according to claim 11, further comprising an optical element through which a laser beam is capable of being directed;
wherein the device and the optical element extend in planes that are plane-parallel to one another, wherein a distance between the planes is selected such that the scattered radiation reflected at an optical interface of the optical element impinges on the first opening or the second opening at an angle in a range of 15° to 30°.

15. The state detection system according to claim 14, further comprising a control unit, to which the detector transmits the received sum signal, wherein the control unit is configured to determine a degree of contamination of the optical interface from the received sum signal.

16. A laser system for aligning a laser beam on a workpiece, the laser system comprising:
the state detection system according to claim 11; and
a processing head that aligns a laser beam on a workpiece.
